(19) United States
(12) Patent Application Publication
(10) Pub. No.: US 2014/0240465 A1
(43) Pub. Date: Aug. 28, 2014

(54) THREE-DIMENSIONAL IMAGE PICKUP APPARATUS, CONVERGENCE DISTANCE ADJUSTMENT METHOD, AND PROGRAM

(71) Applicant: Sony Corporation, Tokyo (JP)

(72) Inventors: Masamiki Kawase, Tokyo (JP); Hiromi Hoshino, Kanagawa (JP)

(73) Assignee: Sony Corporation, Tokyo (JP)

(21) Appl. No.: 14/008,650

(22) PCT Filed: Mar. 15, 2012
(86) PCT No.: PCT/JP2012/001815

§ 371 Date: Sep. 30, 2013

(30) Foreign Application Priority Data
Apr. 7, 2011 (JP) 2011-085564

(51) Int. Cl. H04N 5/232; H04N 13/02

(52) U.S. Cl. CPC H04N 5/232; H04N 13/0239
USPC 348/47

(57) ABSTRACT

[Object] To preferably set a focus distance and a convergence distance.

[Solving Means] A three-dimensional image pickup apparatus 100 is provided with a left lens optical system 121L and a right lens optical system 121R including a pair of right and left image pickup lenses disposed at a predetermined inter axial distance. Further, a focus ring that adjusts the focus of the left lens optical system 121L and the right lens optical system 121R and a control circuit that adjusts a convergence distance from a convergence point at which optical axes of the pair of right and left image pickup lenses are intersected to the image pickup lenses. The control circuit adds the offset distance to the focus distance and adjusts the convergence distance with the offset distance set as a distance from a focus point to a convergence point to be set.

### TECHNICAL FIELD

The present invention relates to a three-dimensional image pickup apparatus, a convergence distance adjustment method, and a program which are preferable when applied to the case where a three-dimensional (3D) image is taken by adjusting a convergence distance, for example.

### BACKGROUND ART

Conventionally, an image pickup system that takes a 3D image is configured by combining two image pickup apparatuses. In the image pickup system, for example, to reproduce a binocular disparity, two image pickup apparatuses are combined with a half mirror and attached to a frame (rig), thereby taking an image. In recent years, an image pickup system has been used in which two right and left lenses are provided to one image pickup apparatus, and these two lenses are used to make it possible to take a 3D image.

In the following description, a point at which lines of sights of right and left eyes of a viewer are intersected is called as a “convergence point”, and an angle formed by the intersecting of the lines of sights is called as a “convergence angle”. The definitions of the convergence point and the convergence angle hold true for the case where the right and left eyes of the viewer are replaced by right and left lens optical systems held by a 3D image pickup apparatus. The convergence is a parameter used when a 3D effect (depth and pop-up) of a 3D image is adjusted. A subject, an image of which is taken at a position of the convergence point, appears to exist on a screen for a viewer who three-dimensionally views the image when the image is projected on the screen. On the other hand, a subject, an image of which is taken in front of the convergence point, appears to jump in front of the screen, and a subject, an image of which is taken behind the convergence point, appears to recede to the back of the screen. Therefore, at the time when a 3D image is taken, it is necessary to adjust the convergence point in addition to adjustments of parameters such as a focus, a zoom, and an iris which are necessary to take a two-dimensional (2D) image by an image pickup apparatus.

Conventionally, a convergence distance from image pickup lenses to a convergence point is changed by adjusting a convergence angle by changing a tilt with respect to optical axes of two right and left lenses provided to a camera. An image taking person who takes a 3D image adjusts a convergence point and a focus point (FP) independently in order to take the 3D image in consideration of a desired convergence point.

Patent Document 1 discloses a technique for adjusting a convergence angle by a manual operation after a focus is automatically adjusted.
Patent Document 1 Japanese Patent Application Laid-open No, 2002-90921

### SUMMARY OF INVENTION

### Problem to be Solved by the Invention

Incidentally, when an image taking person moves a focus first, an operation for readjusting a convergence point in each case to take a desired 3D image by concentrating on the focus moved has to be performed. In contrast, when a convergence point is moved, an operation for readjusting the focus in each case by concentrating on the convergence point moved has to be performed. That is, when one of the focus and the convergence point is moved, to take a 3D image desired by the image taking person, the other one is to be adjusted to a desired position. The operation has to be adjusted each time an image is taken by using a focus ring or a convergence ring, which is a troublesome task. Further, to manually adjust the convergence point by following the focus point while dynamically changing the focus point during the image taking, the image taking person has to possess a high image-taking skill.

In view of the above-mentioned circumstances, the present disclosure has been made and has an object of preferably and easily adjusting a focus point and a convergence distance,

### Means for Solving the Problem

In the present disclosure, a focus point is adjusted by focusing optical systems including a pair of right and left image pickup lenses disposed at a predetermined inter axial distance.

Subsequently, a distance from the focus point in optical axis directions of the image pickup lenses to a convergence point to be set is set as an offset distance.

Further, to a focus distance from the image pickup lenses to the focus point, the offset distance is added, thereby adjusting the convergence distance from the convergence point at which the optical axes of the pair of right and left image pickup lenses are intersected to the convergence point mentioned above.

As a result, it is possible to adjust the convergence distance on the basis of the offset distance and the focus distance.

### Effect of the Invention

According to the present disclosure, after the focus distance is adjusted, the offset distance is added to the focus distance, thereby adjusting the convergence distance. In this way, it is possible to automatically adjust the convergence distance in accordance with the focus distance, so a task of manually and independently adjust the focus distance and the convergence distance is unnecessary, and it is possible to preferably and easily take a 3D image.

### BRIEF DESCRIPTION OF DRAWINGS

FIG. 1 Explanatory diagrams for showing an example of a focus distance, an offset distance, and a convergence distance of a 3D image pickup apparatus according to a first embodiment of the present disclosure.

FIG. 2 A front view showing the 3D image pickup apparatus according to the first embodiment of the present disclosure.

FIG. 3 A left side view showing the 3D image pickup apparatus according to the first embodiment of the present disclosure.

FIG. 4 A perspective view of an adjustment ring according to the first embodiment of the present disclosure.

FIG. 5 A side view showing the adjustment ring according to the first embodiment of the present disclosure.

FIG. 6 A block diagram showing an example of the structure of an adjustment circuit of a zoom, a focus, and a convergence according to the first embodiment of the present disclosure.

FIG. 7 An explanatory diagram of a display example of a setting menu for setting an offset distance according to the first embodiment of the present disclosure.

FIG. 8 An explanatory diagram of an operation example at a time of a zoom adjustment according to the first embodiment of the present disclosure.

FIG. 9 An explanatory diagram of an operation example at a time of a focus adjustment according to the first embodiment of the present disclosure.

FIG. 10 An explanatory diagram of an operation example at a time of a convergence adjustment according to the first embodiment of the present disclosure.

FIG. 11 An explanatory diagram of a display example of a setting menu for setting an offset distance that performs automatic following according to a second embodiment, of the present disclosure.

### MODES FOR CARRYING GUT THE INVENTION

Hereinafter, modes (hereinafter, referred to as embodiments) for carrying out the present disclosure will be described. It should be noted that the description will be given in the following order.

1. First embodiment (example of automatically adjusting convergence distance)

2. Second embodiment (example of causing convergence distance to perform automatic following)

3. Modified example

### 1. First Embodiment

### Example of Automatically Adjusting Convergence Distance

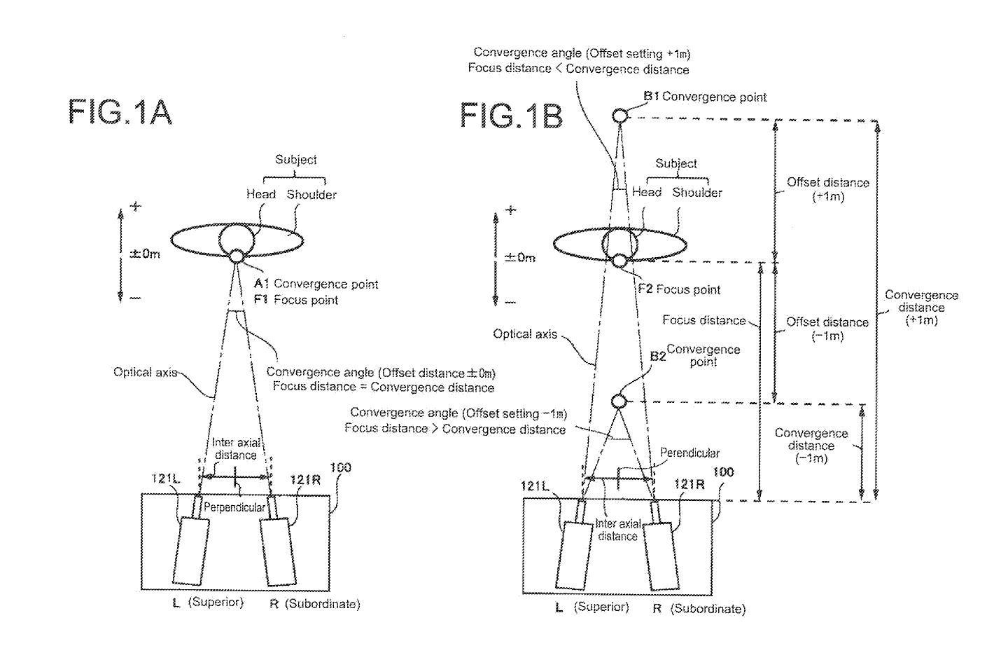

Hereinafter, a first embodiment (hereinafter, referred to as “this example”) of the present disclosure will be described with reference to FIGS. 1 to 10.

In this embodiment, an example of applying twin-lens 3D image pickup apparatus 100 capable of taking an image of the same subject from a plurality of points of view to generate a 3D image will be described. The 3D image pickup apparatus 100 executes a program, thereby achieving a convergence distance adjustment method performed by internal blocks in cooperation with each other. First, the relationship among a focus distance, an offset distance, and a convergence distance will be described with reference to FIG. 1.

(Description of Focus Distance, Offset Distance, and Convergence Distance)

FIGS. 1A and 1B are explanatory diagrams or the focus distance, the offset distance, and the convergence distance. FIG. 1A shows an example in which a focus point and a convergence point coincide with each other at a position where a subject exists.

The 3D image pickup apparatus 100 is provided with a left lens optical system 121L and a right lens optical system 121R including a pair of right and left image pickup lenses disposed at an inter axial distance (IAD), which is equal to a width of right and left eyes of a person. The left lens optical system 121L and the right lens optical system 121R provided to the 3D image pickup apparatus 100 are disposed in slanting directions so that the optical axes of the lenses are intersected toward the subject, and a convergence point of the optical systems is moved forward or backward by using a shift lens (not shown).

The left lens optical system 121L and the right lens optical system 121R have a subordinate superior relationship. An operation of a subordinate optical system is linked, to an operation of a superior optical system. In this example, the left lens optical system 121L is superior, and the right lens optical system 121R is subordinate. Further, the left lens optical system 121L which is superior is directed to a subject and focused thereon. It should be noted that the right lens optical system 121R may be superior, and the left lens optical system 121L may be subordinate.

The 3D image pickup apparatus 100 is disposed in front of the subject, and the left lens optical system 121L and the right lens optical system 121R are focused on a head portion of the person as the subject. In the following description, a distance from an image pickup lens of the left lens optical system 121L to a focus point F1 in the optical axis direction of the left lens optical system 121L is referred to as a “focus distance”. In the same way, a distance from the image pickup lens of the left lens optical system 121L to a convergence point A1 in the optical axis direction of the left lens optical system 121L is referred, to as a “convergence distance”.

The left lens optical system 121L and the right lens optical system 121R are symmetrical with respect to a perpendicular as an axis on a midpoint of the inter axial distance, and the right lens optical system 121R is operated in accordance with the operation of the left lens optical system 121L. Therefore, the focus distance and the convergence distance in the right lens optical system 121R are equal to the distances in the left lens optical system 121L, respectively.

FIG. 1B shows an example in which convergence points B1 and B2 are set.

The optical systems set a focus point F2 on the head portion of the person as the subject to concentrate the focus thereon. Here, a distance to the convergence point B1 or the convergence point B2 when the focus point F2 is set as a reference is referred to as an “offset distance”. For example, in the case where the focus point F2 is set to ±0 m as the reference of the offset distance, the front side from the focus point F2 when viewed from the image pickup lenses is set a negative offset distance, and the back side from the focus point F2 when viewed from the image pickup lens is set to a positive offset distance. Therefore, when the offset distance is set to (−1 m) the convergence point B2 is set to 1 m ahead of the subject. Then, the offset distance (−1 m) is added to the focus distance, thereby obtaining the convergence distance (−1 m) at the convergence point B2. At this time, the relationship of the focus distance>the convergence distance is satisfied.

On the other hand, the offset distance is set to +1 m, the convergence point B1 is set to 1 m behind the subject. Then, the offset distance (±1 m) is added to the focus distance, thereby obtaining the convergence distance (+1 m) at the convergence point B1. At this time, the relationship of the focus distance<the convergence distance is satisfied.

It should be noted that in FIG. 1B, the distance of the left lens optical system 121L as the superior on the optical axis is defined as the “offset distance”, but the distance may be defined again on the center line (perpendicular in this example) of the optical axes of the left lens optical system 121L and the right lens optical system 121R. Further, in the case where it is desired to emphasize that the subject focused exists at the back of the screen, the convergence point may be set to a distance shorter than the focus distance. On the other hand, in the case where it is desired to cause the subject focused to be pop up from the screen, the convergence point may be set to a distance longer than the focus distance.

(Structure of 3D Image Pickup Apparatus)

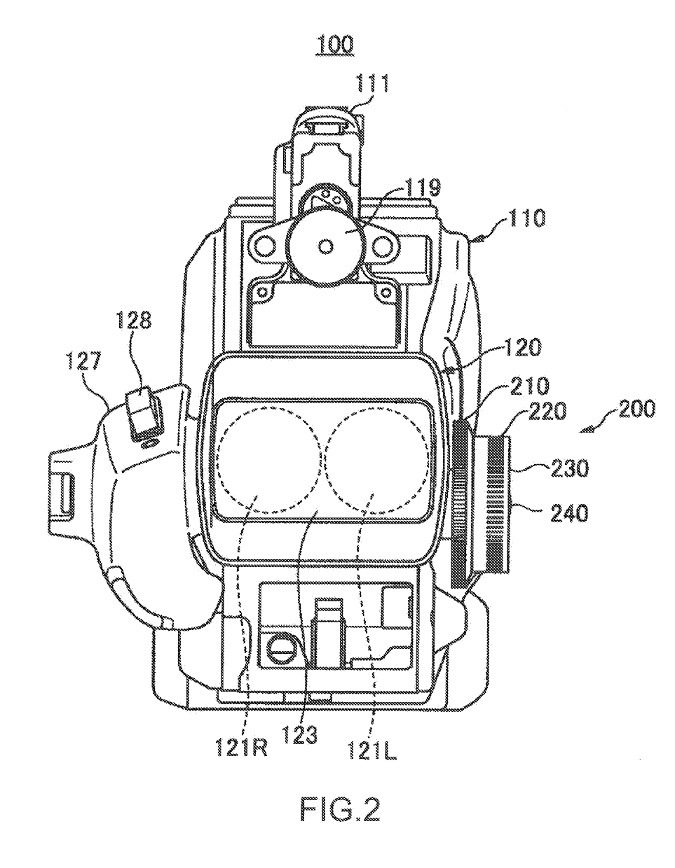

FIG. 2 is a front view showing the 3D image pickup apparatus 100 according to the first embodiment of the present invention.

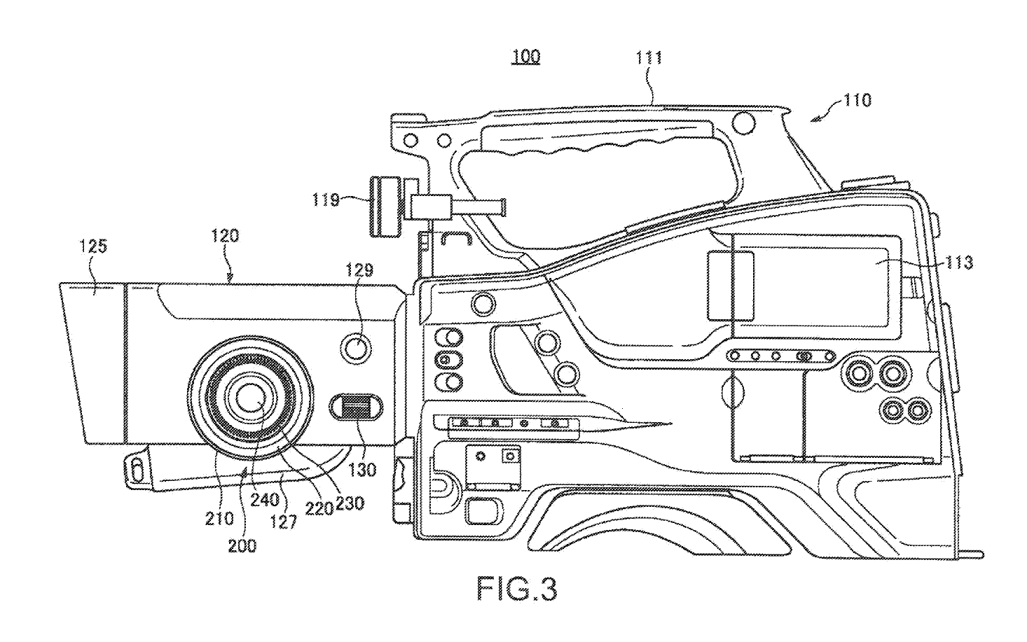

FIG. 3 is a left side view showing the 3D image pickup apparatus 100 according to the first embodiment of the present invention.

The 3D image pickup apparatus 100 includes a main body unit 110 and a lens unit 120.

The twin-lens type 3D image pickup apparatus 100 converts right, and left images of a subject captured through the right and left lenses into electrical signals by an image pickup element and performs an A/D conversion. After that, by a predetermined method such as an HDV (high-definition video) method, compression, coding is performed, thereby recording them in right and left semiconductor recording media. As the image pickup element, for example, a CCD (charge coupled device) imager, a CMOS (complementary metal oxide semiconductor) sensor, or the like is used.

On the side surface of the 3D image pickup apparatus 100, an adjustment ring 200 is provided which is constituted of three rings for making adjustments of a zoom, a focus, and a convergence. The three rings are combined so as to be coaxial and can be operated by being rotated independently of each other. Further, to make adjustments of the zoom, the focus, and the convergence, a zoom ring 210, a focus ring 220, and a convergence ring 230 are provided. To take a desired 3D image by an image taking person, generally, the focus and the convergence are alternately adjusted repeatedly in many cases. However, because the focus ring 220 for the focus adjustment and the convergence ring 230 for the convergence adjustment which are rotatable coaxially with the adjustment ring and independently of each other are used, it is possible to improve efficiency of the adjustment task.

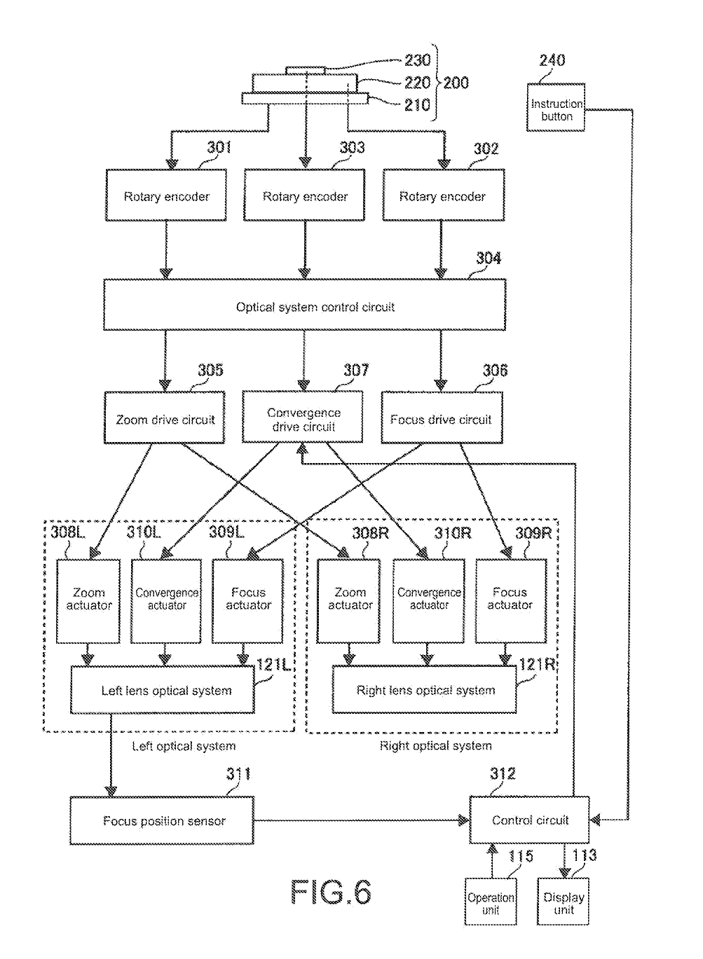

The 3D image pickup apparatus 100 in this example is provided with an instruction button 240 which is disposed on a center portion of the convergence ring 230 and is protruded in the axis direction of the focus ring 220 and the convergence ring 230. When the instruction button 240 is pressed by the image taking person, an instruction to start to adjust the convergence distance is given to a control circuit 312 (see, FIG. 6 to be described later), in addition to the adjustment of the convergence distance by the convergence ring 230. The instruction button 240 is used as an adjustment instruction unit that gives an instruction to start to adjust the convergence distance from the convergence point at which the optical axes of the pair of right and left image pickup lenses are intersected to the image pickup lenses.

In addition, to the main body unit 110, various interface groups used for connection to an external apparatus, various operation button groups, a handle 111, a display unit 113, a battery adapter (not shown), a memory card slot (not shown), and the like are provided. The interface group and the battery adapter are mainly provided on a back portion of the main body unit 110. Examples of the interface include an input and output of digital video and audio, an input and output of analog video and audio, an input for control, a monitor output, a headphone output, or the like. Further, to the battery adapter, a battery (not shown) can be attached and detached.

An operation unit 115, the display unit 113, and the memory card slot are mainly provided on a side surface of the main body unit 110. To the operation unit 115, for example, a power supply button, a record button, a reproduction button, a fast-forward button, a reverse button, a shutter button, and other buttons are included. The display unit 113 is used to display an image which is being taken, a recorded image, a graphical user interface (GUI) or the like for performing function selection or a setting operation or used as a setting unit that sets the offset distance. Further, the display unit 113 is provided ratably on the side surface of the main body unit 110 around the two axes. To and from the memory card slot, a memory card as a semiconductor recording medium can be attached and detached, and the memory card slot can record and read digital image data to and from the memory card.

As the display unit 113, for example, a liquid crystal display, an organic EL display, or the like is used, and in order to check a 3D image while taking an image of the subject by the image taking person, the display unit can be used as a 3D monitor. Further, on the display unit 113, displaying is performed with settings of an autofocus and a manual focus distinguished. It should be noted that the display unit 113 displays only a left image taken by the left lens optical system 121L which is operated as the superior or displays a green left image in the case where an anaglyph is used in which the left image is displayed in green, and a right image is displayed in red, for example. These images may be displayed by a viewfinder (not shown).

A part of the operation button groups and the handle 111 are mainly provided on an upper surface of the main body unit 110. The handle 111 is used by the image taking person in order to support the 3D image pickup apparatus 100. On the front of the handle 111, a microphone 119 is attached, and in the main body unit 110, a control circuit such as a CPU (central processing unit), right and left image pickup elements, a signal processing circuit, an encoder circuit, and the like are accommodated.

To the lens unit 120, the right lens optical system 121R and the left lens optical system 121L are provided in parallel in a right and left direction, and in accordance with the convergence angle set, the optical axes of the right lens optical system 121R and the left lens optical system 121L are tilted. When the left lens optical system 121L is operated, in synchronization with the operation of the left lens optical system 121L, the right lens optical system 121R adjusts the zoom, the focus, and the convergence.

Further, on the end portion of the lens unit 120, a lens filter 123 that restricts a wavelength of light that is incident on the right lens optical system 121R and the left lens optical system 121L is provided. Furthermore, a lens hood 125 that protects the image pickup lenses of the right lens optical system 121R and the left lens optical system 121L for various purposes is provided.

On the side surface of the lens unit 120, in addition to the adjustment rings 200, a grip unit 127 held, by a hand of the image taking person is provided, and to the grip unit 127, a wide-angle/telescopic switch 128 is provided. Further, on the side surface of the lens unit 120, a dark filter button 129 is provided which makes an adjustment to reduce a light quantity that enters the right lens optical system 121R and the left lens optical system 121L. Furthermore, an iris dial 130 which adjusts brightness of an image to be taken by adjusting exposure and the like are also provided.

(Structure of Adjustment Ring)

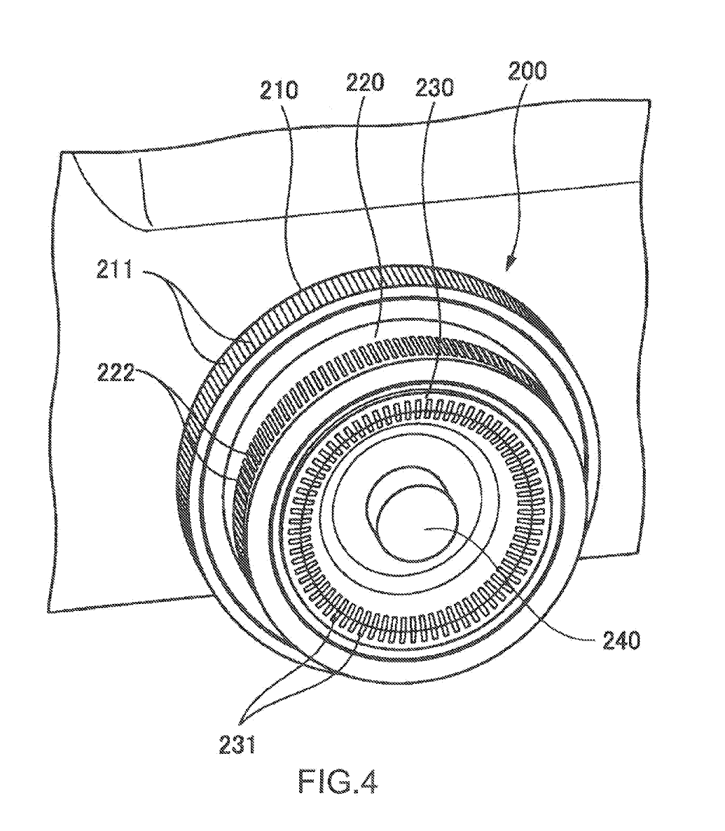

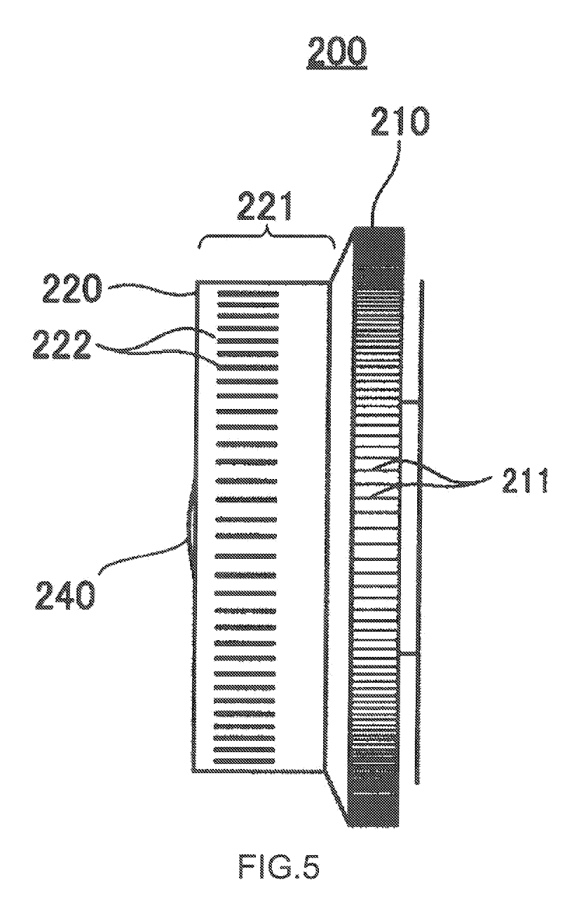

Next, the structure of the adjustment ring 200 will be described with reference to FIGS. 4 and 5.

FIG. 4 is a perspective view showing the adjustment ring 200.

FIG. 5 is a side view showing the adjustment ring 200.

The adjustment ring 200 is constituted of the zoom ring 210 for adjusting the zoom, the focus ring 220 for adjusting the focus, and the convergence ring 230 for adjusting the convergence. The zoom ring 210, the focus ring 220, and the convergence ring 230 are combined in a nested structure and are freely rotatable independently of each other and coaxially in forward and backward directions.

The zoom ring 210 is a rotating unit which is disposed on an outermost side in the adjustment ring 200.

The focus ring 220 is used as a focus adjustment unit that adjusts a focus point by focusing the optical systems by being rotated.

The convergence ring 230 is coaxially combined with the focus ring 220 having a different outer diameter in the nested structure. The convergence ring 230 is rotated independently of the focus ring 220, thereby adjusting the convergence point. Further, the convergence ring 230 is freely rotated on the inner side of the zoom ring 210 and freely rotated on the inner side of the focus ring 220. Thus, the outer diameters of the zoom ring 210, the focus ring 220, and the convergence ring 230 are decreased in order of the zoom ring 210, the focus ring 220, and the convergence ring 230. Therefore, the image taking person can easily recognize the positional relationship of the ring which is being operated, with the result that improvement of the operability is expected.

On an outer circumferential surface of the zoom ring 210, anti-slip slits 211 are formed. Further, the focus ring 220 has a protruded portion 221 protruded in the axis direction from the zoom ring 210. On an outer circumferential surface of the protruded portion 221, anti-slip slits 222 are formed. On the other hand, an end position of the convergence ring 230 disposed freely rotatably on the inner side of the focus ring 220 is set to be equal to or substantially equal to the end portion of the focus ring 220. The end portion of the convergence ring 230 is depressed in a mortar-like shape, and on the inner circumferential surface (slope) of the depressed portion, anti-slip slits 231 are formed.

As described above, the adjustment ring 200 has the structure in which the zoom ring 210 is disposed on the outermost side of the adjustment ring 200. Further, the focus ring 220 is disposed inside the zoom ring 210, and the convergence ring 230 is disposed inside the zoom ring 210. Furthermore, the focus ring 220 is protruded from the zoom ring 210.

However, the structure is not limited to the above structure, and the zoom ring 210 may be disposed on an innermost side of the adjustment ring 200, and on an outer circumference thereof, the focus ring 220 and the convergence ring 230 may be disposed in this order. Alternatively, the convergence ring 230 and the focus ring 220 may be disposed in this order. Further, the adjustment ring 220 may be provided in a place other than the side surface of the main body unit 110 as long as the image taking person performs an easy operation. Furthermore, the convergence ring 230 may be protruded from the focus ring 220, and anti-slip slits may be formed on an outer circumferential surface of the protruded portion of the convergence ring 230.

(Adjustment Circuits for Zoom, Focus, and Convergence)

FIG. 6 is a diagram showing an example of the structure of adjustment circuits for the zoom, the focus, and the convergence.

The 3D image pickup apparatus 100 includes the following circuits respectively corresponding to the zoom ring 210, the focus ring 220, and the convergence ring 230 of the adjustment ring 200. That is, rotary encoders 301, 302, and 303, an optical system control circuit 304, a zoom drive circuit 305, a focus drive circuit 306, and a convergence drive circuit 307 are provided. Further, a left optical system zoom actuator 308L, a left optical system focus actuator 309L, and a left optical system convergence actuator 310L are provided. Similarly, a right optical system zoom actuator 308R, a right optical system focus actuator 309R, and a right optical system convergence actuator 310R are provided. The focus ring 220 is used as a focus adjustment unit that adjusts positions of the focus points (focus distance) of the right lens optical system 121R and the left lens optical system 121L.

Rotation information output by the zoom ring 210, the focus ring 220, and the convergence ring 230 which are subjected to an independent rotation operation is detected by the rotary encoders 301, 302, and 303 provided so as to be corresponded to the respective rings. Detection information obtained by the rotary encoders 301, 302, and 303 is transmitted to the optical system control circuit 304 such as a CPU. On the basis of the detection information of the rotary encoder 301 corresponding to the zoom adjustment, the optical system control circuit 304 obtains a control amount by performing predetermined operation processing relating to the zoom adjustment and supplies control information corresponding to the control amount to the zoom drive circuit 305.

On the basis of the control information, the zoom drive circuit 305 drives the left optical system zoom actuator 3081, and the right optical system zoom actuator 308R. As a result, the zooms of the right lens optical system 121R and the left lens optical system 121L are adjusted. Further, on the basis of the detection information of the rotary encoder 302 corresponding to the focus adjustment, the optical system control circuit 304 obtains a control amount by performing predetermined operation processing relating to the focus adjustment and supplies the control information in accordance with the control amount to the focus drive circuit 306.

On the basis of the control information, the focus drive circuit 306 drives the left optical system focus actuator 309L and the right optical system focus actuator 309R. As a result, the focus adjustment for the right lens optical system 121R and the left lens optical system 121L is made.

Further, the optical system control circuit 304 obtains a control amount by performing predetermined operation processing relating to the convergence adjustment on the basis of the detection information of the rotary encoder corresponding to the convergence adjustment. Then, control information corresponding to the control amount is supplied to the convergence drive circuit 307. On the basis of the control information, the convergence drive circuit 307 drives the left optical system convergence actuator 310L and the right optical system convergence actuator 310R. As a result, the convergence adjustment for the right lens optical system 121R and the left lens optical system 121L is made.

In addition, the 3D image pickup apparatus 100 is provided with a focus position sensor 311 serving as a focus distance detection unit that detects a focus distance from the image pickup lens to the focus point on the basis of the inter axial distance and the focus point from the information received from the left lens optical system 121L. By applying triangulation, the focus position sensor 311 can obtain the focus distance from the inter axial distance and the focus point which are obtained in advance.

In addition, the 3D image pickup apparatus 100 is provided with the control circuit 312 that obtains the convergence distance on the basis of the focus distance. The control circuit 312 is used as a control unit that adjusts the convergence distance from the image pickup lenses to the convergence point, when the instruction button 240 that gives an instruction to start to adjust the convergence distance is pressed. At this time, after the focus point is adjusted by the focus ring 220, the control circuit 312 sets, as the offset distance, a distance from the focus point of the image pickup lenses in the optical axis direction to the convergence point to be set. Then, the offset distance is added to the focus distance from the image pickup lenses to the focus point, thereby adjusting the convergence distance from the image pickup lens to the convergence point.

Here, as described above with reference to FIG. 1B, in the case where the adjustment is made so that the convergence point is disposed behind the focus point, the control circuit 312 adds a positive offset distance to the focus distance. On the other hand, in the Case where the adjustment is made so that the convergence point is disposed in front of the focus point, the control circuit 312 adds a negative offset distance to the focus distance. As a result, it is possible to automatically adjust the convergence distance in accordance with the focus distance only by pressing the instruction button 240 by the image taking person.

As described above, the 3D image pickup apparatus 100 presents the instruction button 240 for performing the automatic adjustment of the convergence distance and a menu for setting the positional relationship between the convergence point and the focus point. The menu may include a GUI displayed on the display unit 113, but the function of the menu may be implemented by the operation button or the like attached to the main body unit 110. By using this menu, it is possible for the image taking person to set a desired positional relationship (distance) between the convergence point and the focus point as the offset distance in advance. Then, after the focusing is performed at the time of image taking, only by a pressing operation for the instruction button 240, the 3D image pickup apparatus 100 automatically adjusts the convergence point position. Therefore, it is possible to simplify the adjustment task for the convergence point of the focus point which is manually performed by the image taking person and easily obtain a desired 3D image.

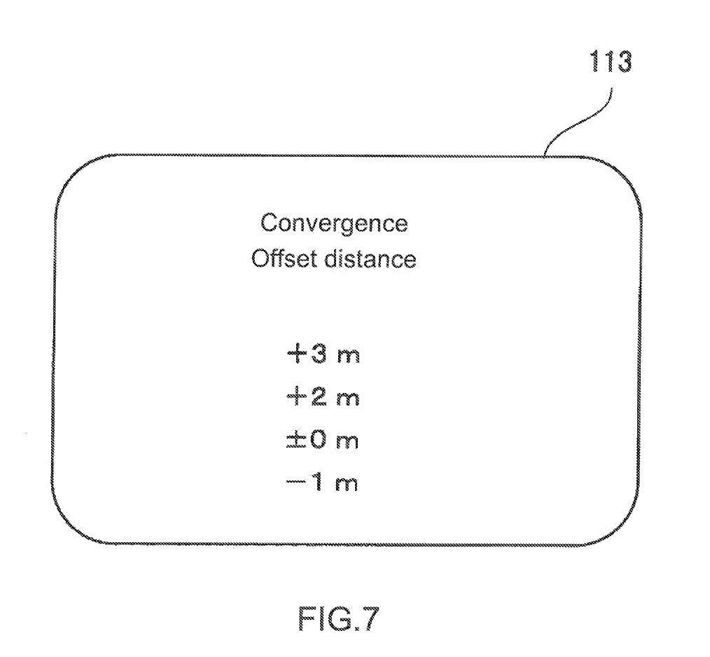

FIG. 7 is a diagram showing a display example of a setting menu for setting the offset distance which is displayed on the display unit 113.

When the input operation for the operation unit 115 is performed, the control circuit 312 displays a menu screen used to set a value of the offset distance by the image taking person, on the display unit 113. By the operation input for the operation unit 115, the image taking person can set in advance the offset distance used to calculate the convergence distance as a “convergence offset distance”. Therefore, when the instruction button 240 is pressed at the time when a 3D image is taken, the 3D image pickup apparatus 100 can adjust the convergence distance in accordance with the offset distance set.

(Example of Selection Operation)

Here, an example of a selection operation will be described.

First, the image taking person selects a value of the offset distance from the menu screen for setting the offset distance which is displayed on the display unit 113.

At the time of image taking, after the focusing on a subject is performed, on the basis of the offset distance selected, the control circuit 312 obtains a convergence angle on the basis of the focus distance obtained from the focus position sensor 311. Then, the control circuit 312 changes the optical axes of the image pickup lenses in the left lens optical system 121L and the tight lens optical system 121R with respect to the convergence drive circuit 307, thereby setting the convergence angle in accordance with the convergence point.

For example, the convergence distance is obtained as follows.

In the case where the offset distance set through the operation unit 115 from the menu screen of the display unit 113 is +1 m, and the focus distance is 3 m, the convergence distance of 4 m=3 m+1 m is set. At this time, an intersecting point of arcs each having a radius of 4 m is determined from the left lens optical system 121L and the right lens optical system 121R. Then, the control circuit 312 determines an angle (convergence angle θ) of the optical axes to the intersecting point of the arcs from the left lens optical system 121L and the right lens optical system. 121R from a table (or calculation). In the table, a relationship of the convergence angle to the focus distance is stored in advance. Therefore, the control circuit 312 gives an instruction to adjust the convergence to the convergence drive circuit 307 so as to cause the convergence point to move in accordance with the convergence angle. As a result, a part of the lens group (for example, shift lens) is driven on an orthogonal plane of the optical axes of the image pickup lenses, a horizontal direction, or a right and left direction, and the convergence angle is set to the predetermined value θ.

After that, the image taking person checks an effect of the 3D image taking while viewing an image displayed on the display unit 113. Here, if the 3D image taking intended is not implemented, the offset distance is set again. For the display unit 113, the 3D viewfinder or the 3D monitor is used, so the image taking person can check the effect of the 3D image taking in real time. However, the 3D image can be checked on the basis of reproduced video data by reading the image from an HDD (not shown) or the like.

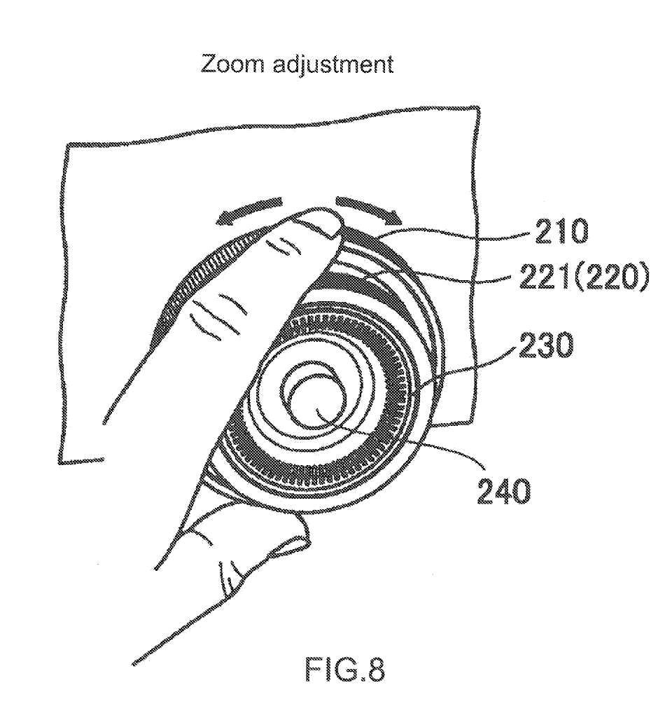

Next, an operation example of the adjustment ring 200 will be described with reference to FIGS. 8 to 10.

FIG. 8 is a diagram showing an operation example at the time of the zoom adjustment.

The image taking person fits the fingers to the outer circumferential surface of the zoom ring 210 at the time of the zoom adjustment to rotate and operate the zoom ring 210. By this operation, rotation information is detected by the rotary encoder 301, with the result that the zoom adjustment can be made.

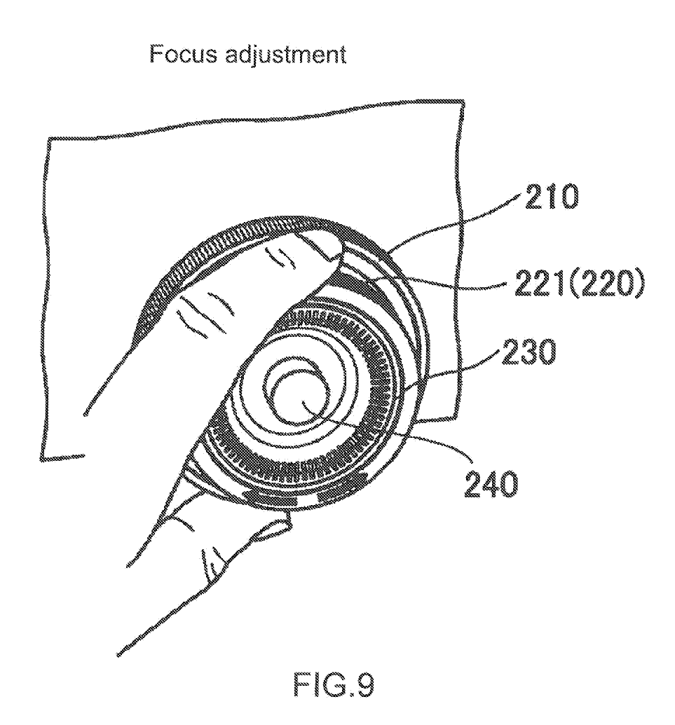

FIG. 9 is a diagram showing an operation example at the time of the focus adjustment.

The image taking person fits the fingers to the outer circumferential surface of the protruded portion 221 of the focus ring 220 at the time of the focus adjustment to rotate and operate the focus ring 220. By this operation, rotation information is detected by the rotary encoder 302, with the result that the focus adjustment can be made.

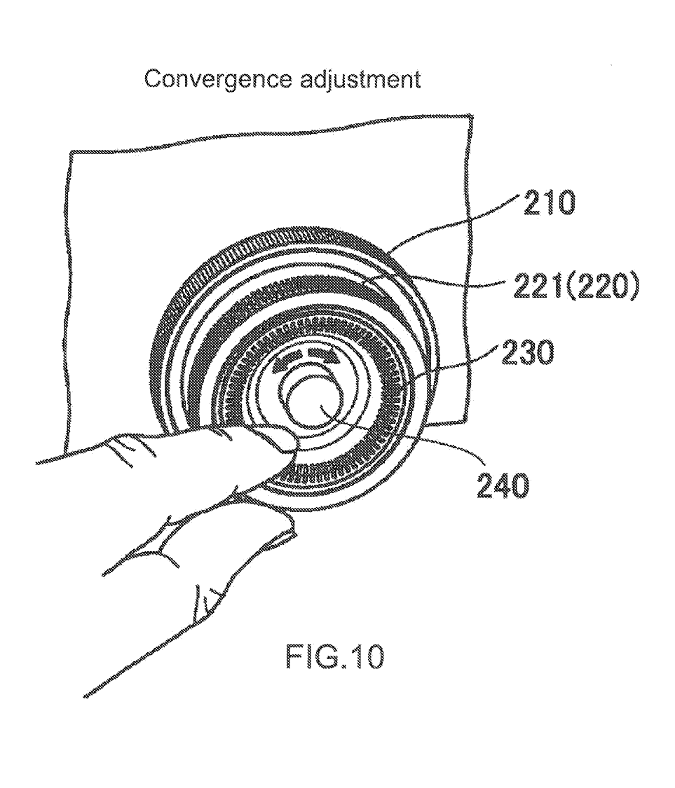

FIG. 10 is a diagram showing an operation example at the time of the convergence adjustment.

The image taking person fits the fingers to the inner circumferential surface of the mortar-like depressed portion of the end portion of the convergence ring 230 at the time of the convergence adjustment to rotate and operate the convergence ring 230. By this operation, rotation information is detected by the rotary encoder 303, with the result that the convergence adjustment can be made.

The zoom ring 210, the focus ring 220, and the convergence ring 230 are coaxially combined and integrated as the adjustment ring 200. Therefore, the image taking person can smoothly change an adjustment target among the zoom, the focus, and the convergence only by slightly moving the image taking person's hand. Further, because the zoom ring 210, the focus ring 220, and the convergence ring 230 are coaxially rotated, the same operation feeling can be obtained. Thus, immediately after an adjustment target is changed, it is possible to start another adjustment. In particular, in the adjustment tasks which are alternately and repeatedly performed like the focus and convergence adjustments, the improvement of efficiency can be expected.

As described above, the zoom ring 210, the focus ring 220, and the convergence ring 230 are coaxially combined and integrated as the adjustment ring 200. With this structure, it is possible to smoothly change the adjustment target among the zoom, the focus, and the convergence only by slightly moving a hand of the image taking person. Further, the zoom ring 210, the focus ring 220, and the convergence ring 230 are coaxially rotated, and setting values are not changed when the rings are not touched. Therefore, in the case where the image taking person moves the hand off after the adjustment and makes the adjustment again, it is possible to restart making the adjustment from the value previously set. In particular, in the adjustment tasks alternately and repeatedly performed like the focus and the convergence, the improvement of efficiency can be expected. Further, in the case where the focus adjustment becomes necessary by the zoom adjustment, efficiency of the adjustment tasks including the zoom adjustment can be increased.

By the 3D image pickup apparatus 100 according to this embodiment described above, it is possible to easily set the convergence distance in accordance with the offset distance only by pressing the instruction button 240. Therefore, as compared to the case where the focus distance and the convergence distance are individually set by manual operations as in related art, it is possible to significantly reduce time until changing of the convergence distance is completed. Further, because the offset distance set once is not changed, it is possible to stably take the 3D image having a constant offset distance only by pressing the instruction button 240, and a feeling of strangeness in the 3D image due to the change of the offset distance during the image taking is not generated. Thus, it is possible to achieve the easy operability of the 3D image pickup apparatus 100 in the case where a high-quality 3D image is taken.

Further, the instruction button 240 is disposed with the button protruded in the axis direction on the center portion of the adjustment ring 200. Therefore, there is no possibility that the image taking person mistakenly touches the instruction button 240 in an ordinary operation, and a non-intended 3D image is prevented from being taken.

In addition, it is possible to set the offset distance to any value by a user. Therefore, the offset distance is easily changed, and it is possible to reduce time and effort of an operation when images of the same subject having slightly different convergence distances are taken.

### 2. Second Embodiment

### Example of Causing Convergence Distance to Perform Automatic Following

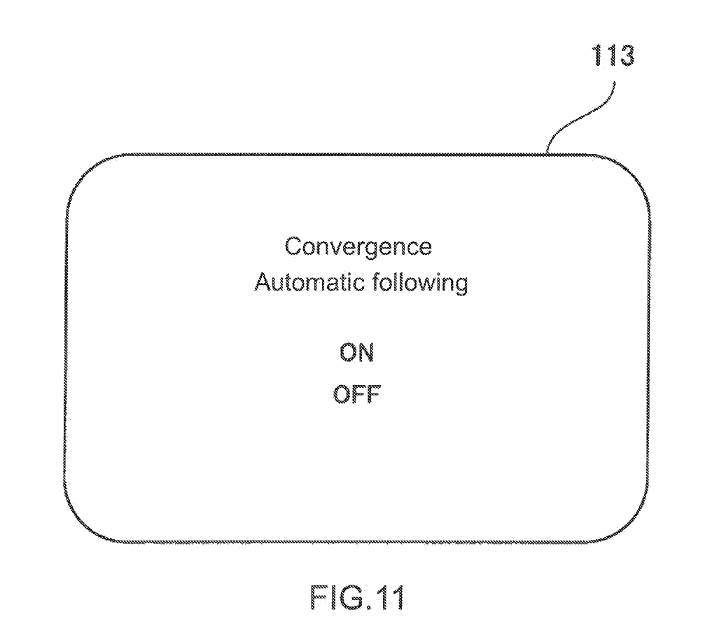

Next, a second embodiment of the present embodiment will be described with reference to FIG. 11. In this embodiment, description will be given on an example of application to the 3D image pickup apparatus 100 in which even, in the case where a focus distance is changed by an autofocus or the like when a 3D image is being taken, the convergence distance is changed by being caused to automatically follow a change of the focus distance. In the following description, the parts corresponding to those in FIGS. 1 to 4 described in the first embodiment are denoted by the same reference symbols, and detailed description thereof will be omitted.

FIG. 11 is a diagram showing a display example of a setting menu for setting an offset distance to be automatically followed.

The control circuit 312 displays, on the display unit 113, a menu screen for selecting whether the convergence point is caused to automatically follow a focus point adjusted by the focus ring 220, and the convergence distance is adjusted or not. When the image taking person sets the automatic following to be on, after the setting time point, even if the focus point is dynamically changed, the focus position sensor 311 automatically obtains a focus distance. Then, the control circuit 312 adjusts the convergence distance by causing the convergence point to achieve the automatic following on the basis of the focus distance so that the offset distance set in advance is maintained.

By the 3D image pickup apparatus 100 according to the second embodiment described above, by turning the automatic following by the convergence point on, even if the image taking person uses the autofocus or the like to dynamically change the focus point, the convergence point is automatically changed, with the result that the convergence distance is adjusted. Thus, in the case where an image of a moving subject, a subject that moves backwards, or the like is taken, only by the focusing, a 3D image is easily taken on the basis of the convergence distance intended. In this way, a complicated operation for setting the convergence point is unnecessary for the image taking person, and the image taking person can concentrate on the image taking, so it is possible to increase the quality of the 3D image taken.

### 3. Modified Example

It should be noted that the automatic following may initially set to be on without particularly providing the menu screen for the automatic following of the convergence point. As a result, even if the image taking person moves the focus point manually or by the autofocus, it is possible to take a preferable 3D image without considering the setting of the convergence point.

In addition, in the first and second embodiments, the focus ring 220 is used as the focus adjustment unit, the convergence ring 230 is used as the convergence adjustment unit, and the instruction button 240 is used as the adjustment instruction unit. However, the focus adjustment unit, the convergence adjustment unit, and the adjustment instruction unit may not be limited to the rings, and a slide switch or various switch mechanisms may be used therefor. Further, by a menu displayed in the GUI on the display unit 113, various values may be adjusted.

In addition, in the first and second embodiments, the example of the application to the twin-lens 3D image pickup apparatus 100 is described, but as in related art, application to an image pickup system that generates a 3D image by using two cameras is possible.

In addition, the series of processes in the above embodiments can be executed by hardware but can also be executed by software. In the case where the series of processes are executed by software, the software can be executed by a computer in which a program that configures the software is incorporated in dedicated hardware or a computer in which programs for executing various functions are installed. For example, a program that configures desired software may be installed in a general-purpose personal computer or the like and executed.

Further, a recording medium in which a program code of software that implements the functions of the above embodiments may be supplied to a system or an apparatus. Furthermore, of course, the functions are also implemented by reading and executing a program code stored in a recording medium by a computer (or a control apparatus such as a CPU) of the system or the apparatus.

As the recording medium for supplying the program code in this case, for example, a flexible disk, a hard disk, an optical disk, a magneto-optical disk, a CD-ROM, a CD-F, a magnetic tape, a non-volatile memory card, a ROM, or the like can be used.

Further, by executing the program code read by a computer, the functions of the above embodiments are implemented. In addition, on the basis of an instruction of the program code, an OS or the like that operates on a computer partially or entirely performs actual processing. The case where the functions of the above embodiments are implemented through the processing is also included.

Furthermore, the present disclosure is not limited to the above embodiments, and can of course have various other application examples and modified examples without departing from the gist of the present disclosure described in the scope of claims.

It should be noted that the present disclosure can have the following configuration.

(1) A three-dimensional image pickup apparatus, including:

optical systems including a pair of right and left image pickup lenses disposed at a predetermined inter axial distance;

a focus adjustment unit that adjusts a focus point by focusing the optical systems; and

a control unit that adds an offset distance to a focus distance from the image pickup lenses to the focus point after the focus point is adjusted by the focus adjustment unit, and adjusts a convergence distance from the image pickup lenses to a convergence point to be set, the offset distance being a distance from the focus point in optical axis directions of the image pickup lenses to the convergence point.

(2) The three-dimensional image pickup apparatus according to Item (1), in which

the control unit adds a positive offset distance to the focus distance when making an adjustment so that the convergence point is located posterior to the focus point, and adds a negative offset distance to the focus distance when making an adjustment so that the convergence point is located anterior to the focus point.

(3) The three-dimensional image pickup apparatus according to Item (1) or (2), further including:

a setting unit that sets the offset distance;

an adjustment instruction unit that gives an instruction to start to adjust the convergence distance; and

a focus distance detection unit that detects a focus distance from the image pickup lenses to the focus point on the basis of the inter axial distance and the focus point.

(4) The three-dimensional image pickup apparatus according to any one of Items (1) to (3), in which

the focus adjustment unit is a focus ring that adjusts a focus of the optical system by being rotated,

the three-dimensional image pickup apparatus further including a convergence ring that is coaxially combined with the focus ring having a different outer diameter in a nested structure and adjusts the convergence distance by being rotated independently of the focus ring, in which

the adjustment instruction unit is a button that is protruded in an axis direction of the focus ring and the convergence ring and gives an instruction to the control unit to start an adjustment of the convergence distance by being pressed, independently of the adjustment of the convergence distance by the convergence ring.

(5) The three-dimensional image pickup apparatus according to any one of Items (1) to (4), in which

the control unit displays a menu screen for setting a value of the offset distance on a display unit.

(6) The three-dimensional image pickup apparatus according to any one of Items (1) to (4), in which

the control unit displays, on the display unit, the menu screen for causing whether or not the control unit adjusts the convergence distance by following the focus adjusted by the focus adjustment unit to be selected.

(7) A convergence distance adjustment method, including:

focusing optical systems including a pair of right and left image pickup lenses disposed at a predetermined inter axial distance and adjusting a focus point; and

adding an offset distance to a focus distance from the image pickup lenses to the focus point and adjusting a convergence distance from the image pickup lenses to a convergence point to be set, the offset distance being a distance from the focus point in optical axis directions of the image pickup lenses to the convergence point.

(8) A program causing a computer to execute the steps of

focusing optical systems including a pair of right and left image pickup lenses disposed at a predetermined inter axial distance and adjusting a focus point, and

adding an offset distance to a focus distance from the image pickup lenses to the focus point and adjusting a convergence distance from the image pickup lenses to a convergence point to be set, the offset distance being a distance from the focus point in optical axis directions of the image pickup lenses to the convergence point.

### DESCRIPTION OF SYMBOLS

100 three-dimensional image pickup apparatus
110 main body unit
113 display unit
115 operation unit
120 lens unit
121L left lens optical system
121R right lens optical system
123 lens filter
125 lens hood
200 adjustment ring
210 zoom ring
220 focus ring
230 convergence ring
240 setting button
311 focus position sensor
312 control circuit

1. A three-dimensional image pickup apparatus, comprising:
optical systems including a pair of right and left image pickup lenses disposed at a predetermined inter axial distance;
a focus adjustment unit that adjusts a focus point by focusing the optical systems; and
a control unit that adds an offset distance to a focus distance from the image pickup lenses to the focus point after the focus point is adjusted by the focus adjustment unit, and adjusts a convergence distance from the image pickup lenses to a convergence point to be set, the offset distance being a distance from the focus point in optical axis directions of the image pickup lenses to the convergence point.

2. The three-dimensional image pickup apparatus according to claim 1, wherein
the control unit adds a positive offset distance to the focus distance when making an adjustment so that the convergence point is located posterior to the focus point, and adds a negative offset distance to the focus distance when making an adjustment so that the convergence point is located anterior to the focus point.

3. The three-dimensional image pickup apparatus according to claim 2, further comprising:
a setting unit that sets the offset distance;
an adjustment instruction unit that gives an instruction to start to adjust the convergence distance; and
a focus distance detection unit that detects a focus distance from the image pickup lenses to the focus point on the basis of the inter axial distance and the focus point.

4. The three-dimensional image pickup apparatus according to claim 3, wherein
the focus adjustment unit is a focus ring that adjusts a focus of the optical systems by being rotated,
the three-dimensional image pickup apparatus further comprising a convergence ring that is coaxially combined with the focus ring having a different outer diameter in a nested structure and adjusts the convergence distance by being rotated independently of the focus ring, wherein
the adjustment instruction unit is a button that is protruded in an axis direction of the focus ring and the convergence ring and gives an instruction to the control unit to start an adjustment of the convergence distance by being pressed, independently of the adjustment of the convergence distance by the convergence ring.

5. The three-dimensional image pickup apparatus according to claim 4, wherein
the control unit displays a menu screen for setting a value of the offset distance on a display unit.

6. The three-dimensional image pickup apparatus according to claim 5, wherein
the control unit displays, on the display unit, the menu screen for causing whether or not the control unit adjusts the convergence distance by following the focus adjusted by the focus adjustment unit to be selected.

7. A convergence distance adjustment method, comprising:
focusing optical systems including a pair of right and left image pickup lenses disposed at a predetermined inter axial distance and adjusting a focus point; and
adding an offset distance to a focus distance from the image pickup lenses to the focus point and adjusting a convergence distance from the image pickup lenses to a convergence point to be set, the offset distance being a distance from the focus point in optical axis directions of the image pickup lenses to the convergence point.

8. A program causing a computer to execute the steps of
focusing optical systems including a pair of right and left image pickup lenses disposed at a predetermined inter axial distance and adjusting a focus point, and
adding an offset distance to a focus distance from the image pickup lenses to the focus point, and adjusting a convergence distance from the image pickup lenses to a convergence point to be set, the offset distance being a distance from the focus point in optical axis directions of the image pickup lenses to the convergence point.
